(19) United States
(12) Patent Application Publication
(10) Pub. No.: US 2004/0042034 A1
(43) Pub. Date: Mar. 4, 2004

(54) Facsimile transmission according to recipient preferences

(76) Inventors: Jeff Tiffan, Greeley, CO (US); Jeff Wiley, Greeley, CO (US); Mike Erickson, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/233,967

(22) Filed: Sep. 3, 2002

(51) Int. Cl. G06F 13/00; G06F 15/00

(52) U.S. Cl. 358/1.15; 358/1.2

(57) ABSTRACT

A communications device for distributing an image of a paper document to a plurality of recipients having a database comprising a preferred electronic format of each of the recipients and an imaging device for converting the paper document into the preferred electronic format for each recipient in the database prior to distribution of the document in the preferred electronic format.

### TECHNICAL FIELD

The subject matter disclosed here generally relates to facsimile transmission and, more particularly, to a communication method and device for distributing an image of a paper document to a plurality of recipients in a preferred format for each recipient.

### BACKGROUND

Various commercially-available software packages allow the distribution of scanned paper documents via e-mail, the Internet, or conventional telephone facsimile. For example, the Acrobat Messenger® software available from Adobe Systems Inc., of Palo Alto, Calif. runs on a dedicated Windows NT workstation and automates the creation and distribution of electronic files from paper input. The Adobe system requires users to provide a scanner with an ISIS-compliant (“Image and Scanner Interface Specification” by Pixel Translations) interface. According to Adobe, common TWAIN-compliant (sometimes referred to as “Technology Without an Interesting Name”) scanners are not guaranteed to work. The user must therefore provide and configure an appropriate scanner in order to implement the Adobe product.

In contrast, the Hewlett-Packard (HP) Company offers another product with an embedded imaging device. The Hewlett-Packard product is generally referred to as the “HP Digital Sender” and is described in the “Index to Architecture of the HP 9100C Digital Sender,” which is hereby incorporated by reference in its entirety. FIG. 1 is a schematic diagram of the network architecture for a prior art system for distributing paper documents in electronic format. FIG. 1 illustrates a local area network (“LAN”) 100 using the transmission control protocol/Internet protocol (TCP/IP) communications protocol with a digital sender device 110. It should be noted that the HP Digital Sender technology is typically implemented as part of a LAN, such as the LAN of FIG. 1. Any, or all, of the other components shown in FIG. 1 may also be connected to the LAN 100 depending upon functionality required by the user, as is described in detail below. It should be noted that the digital sender device 110 may instead be implemented as part of a wide area network (WAN).

The digital sender device 110 receives data and/or other network services from various other remote devices that are connected to the LAN 100. For example, sending documents via Internet e-mail to single or multiple e-mail addresses is achieved by configuring the LAN 100 with a remote e-mail server device 120 having a connection to the Internet 125. The digital sender device 110 also supports lightweight directory access protocol (LDAP) queries if an LDAP server device 130 is also configured for communication with the LAN 100.

The LAN 100 may be further configured with a fax server 140 that is connected to the public switched telephone network (“PSTN”) 145. Hewlett-Packard offers digital sender service software 150 that is installed on the network fax server 140 in order to provide facsimile communication capabilities. The digital sender service software 150 also allows document data to be transferred to third-party applications running on a Windows NT server 160. Digital sender link software 175 allows the digital sender device 110 to provide document images to a personal computer 170 for further manipulation and/or archiving. Finally, the digital sender device 110 also allows direct point to point communication with a network printer 180 when connected with an HP JetDirect card (not shown).

FIG. 2 is a block diagram illustrating a prior art architecture of the digital sender device 110 shown in FIG. 1. The digital sender device 110 architecture comprises an embedded processor 220, embedded scanner 230, memory 240, network interface device 250, and a control panel 260 that communicate over a local bus 270. The processor 220 operates in conjunction with data and/or instructions from the scanner 230, memory 240, network interface device 250, and/or control panel 260. For example, information from the servers 120, 130, 140, 160 (FIG. 1) maybe received from the network interface device 250 and user input may be received from the embedded control panel 260.

The embedded scanner 230 receives paper documents and provides electronic data corresponding to images on those documents. The memory 240 also comprises an image converter 242 for converting data from the scanner 230 into portable document format (“.pdf”) or tagged image file format (.“tiff”). The memory 240 further comprises an operating system 241 that provides instructions and data to the processor 220. Embedding the scanner 230 in the digital sender device 110 eliminates the need for a user to provide, connect, and/or configure a remote scanner with the LAN 100 shown in FIG. 1.

The digital sender device 110 is just one example of a communication device of the type having a document scanner for distributing an image of paper documents to a plurality of recipients. Although such communication devices typically offer a great deal of flexibility in choosing the electronic format in which an image is sent to a recipient, the number of electronic formats to select from makes selection of an electronic format overwhelming, especially for new users. In addition, not all recipients have appropriate software or hardware to handle images in all of the electronic formats. For example, some recipients may be limited as to the file type, file size, and/or image resolution allowed by their software and/or hardware.

Various publications describe automatic document format conversion based upon user preferences. For example, U.S. Pat. No. 6,101,320 discloses a system and method for determining the electronic mail format used by a recipient organization and then converts electronic mail into the format used by the recipient. This and other references are incorporated by reference along with U.S. Pat. Nos. 6,023,700, 5,751,960, and 5,283,887, and WIPO Publication No. WO 00/41533 and EP Publication No. EP 1045554. Although these references discuss various conversion techniques for electronic mail systems, they are not configured with imaging devices such as scanners.

### SUMMARY

These and other drawbacks of conventional technology are addressed here by providing a communication device for distributing an image of a paper document to a plurality of recipients, comprising a database comprising a preferred electronic format of each of the recipients, and an imaging device for converting the paper document into the preferred electronic format for each recipient in the database prior to distribution of the document in the preferred electronic format.

The invention also provides a communications device of the type having an embedded document scanner for distributing an image of a paper document to a plurality of recipients, the improvement comprising means for associating each recipient with a preferred electronic format, and means for converting the image into the preferred electronic format for each recipient prior to distribution.

In yet another embodiment, this technology provides a communications method for distributing an image of a paper document to a plurality of recipients, the method comprising the steps of associating each recipient with a preferred electronic format for receiving the image and scanning the image according to the preferred electronic format for each recipient prior to distribution of the image.

### BRIEF DESCRIPTION OF THE DRAWINGS

Various aspects of the invention will now be described with reference to the following figures (“FIGS. ”) which are not necessarily drawn to scale, but use the same reference numerals to designate corresponding parts throughout each of the several views.

FIG. 1 is a schematic diagram of the network architecture for a prior art system for distributing paper documents in electronic format.

FIG. 2 is a block diagram illustrating a prior art architecture of the digital sender device of FIG. 1.

FIG. 3 is a block diagram illustrating a first exemplary embodiment of a device architecture for an improved communication device.

FIG. 4 is a flow diagram illustrating a first exemplary embodiment of a communication method for distributing an image of a paper document to a plurality of recipients.

FIG. 5 is a flow diagram illustrating preparation of the communication device of FIG. 3 for distributing an image of a document to a recipient in a format preferred by the recipient.

### DETAILED DESCRIPTION

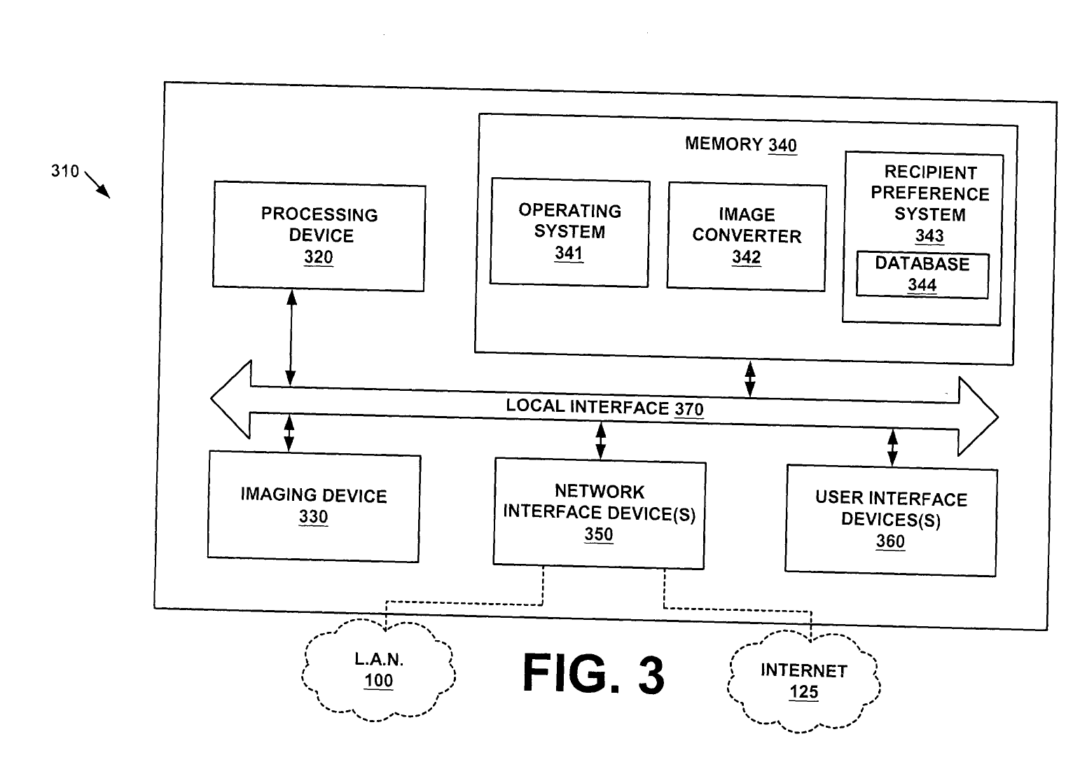

FIG. 3 is a block diagram illustrating a first exemplary embodiment of a device architecture for an improved communication device 310 comprising a recipient reference system 343. The communication device 310 may be implemented in a wide variety of electrical, electronic, computer, mechanical, and/or manual configurations. However, in a preferred embodiment, the communication device 310 is at least partially computerized with various aspects of the recipient reference system 343 being implemented by software, firmware, hardware, or a combination thereof. Depending on the particular configuration of the communication device 310, the device 310 may comprise additional or fewer components than are illustrated by FIG. 3.

The communication device 310 of FIG. 3 comprises at least a processing device 320, an embedded imaging device 330, a memory 340, one or more network interface devices 350, one or more user interface devices 360, and a local interface 370. The term “embedded” is used herein to broadly refer to software and/or hardware that is locally incorporated or implemented within the communication device 310, rather than remotely distributed on a network to which the communication device 310 is connected.

In accordance with the first exemplary embodiment, the local interface 370 may comprise, but is not limited to, one or more buses or other wired and/or wireless connections. Although not shown in FIG. 3, the local interface 370 may also have other communication elements, such as controllers, buffers (caches), drivers, repeaters, and/or receivers. Various address, control, and/or data connections may also be provided in the local interface 370 for enabling communication among the various hardware components of the communication device 310.

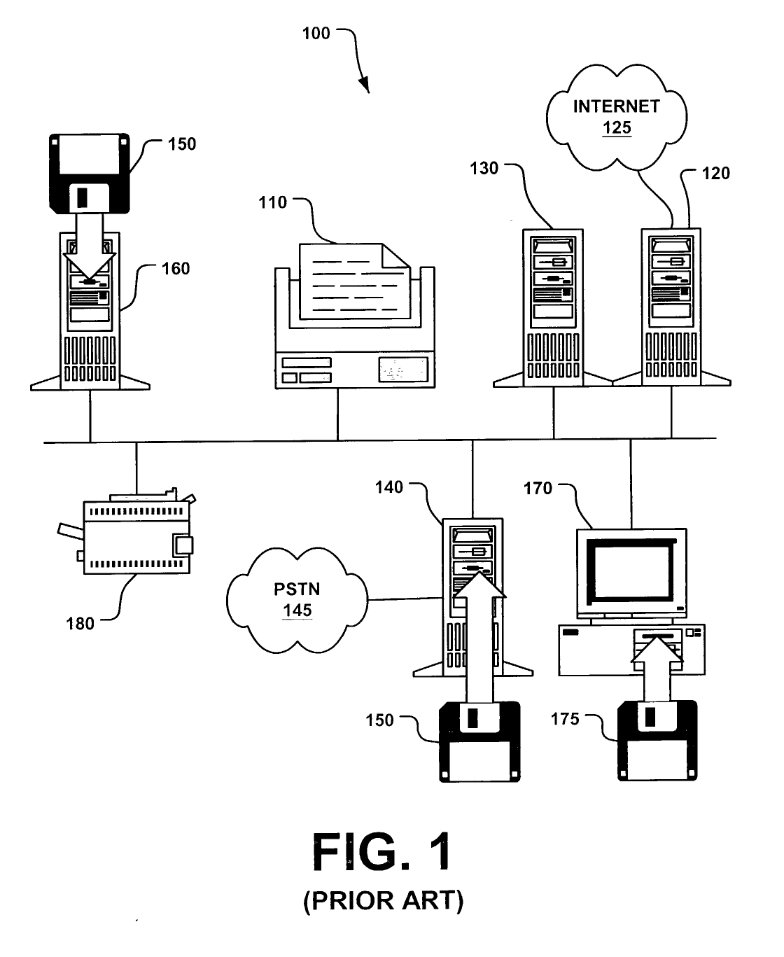

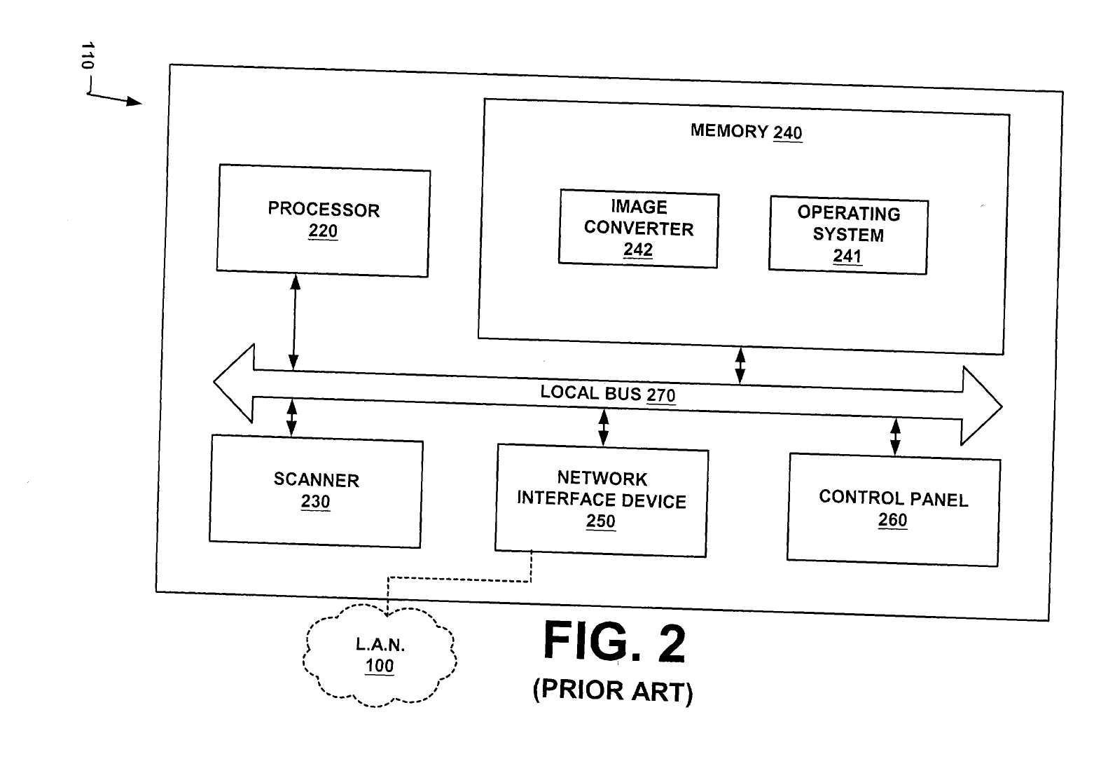

The user interface device(s) 360 and network interface device(s) 350 are input/output (“I/O”) devices for allowing a user and remote devices, respectively, communicate with the communication device 310. For example, the user interface device(s) 360 may be, but is not limited to, a control panel (such as the control panel 260 shown in FIG. 2), a display screen, a touch-sensitive screen, a keyboard, a keypad, a touch-pad, a serial port, a parallel port, a mouse, speakers, and/or a microphone. The network interface device(s) 350 may be any device configured to facilitate communication between the communication device 310 and an external network or device. For example, the network examples illustrated in FIG. 3 comprise the local area network (LAN) 100 and the Internet 125 shown in FIG. 1. However, network interface devices may also be provided for communicating with other local and wide area networks comprising wireless networks, optical networks, packet-switched networks, circuit-switched networks, store and forward networks, or any other desired communications infrastructure. Other types of interface support may also be provided, such as for direct communication with the digital sender device 110 of FIG. 1.

The memory 340 may comprise any, or a combination of, volatile memory elements (e.g., random access memory (RAM), such as dynamic RAM (DRAM), static RAM (SRAM), synchronous DRAM (SDRAM), etc.) and nonvolatile memory elements (e.g., read only memory (ROM), hard drive, tape, compact disc ROM (CDROM), digital versatile disk (DVD), etc.). The memory 340 may incorporate electronic, magnetic, optical, and/or other types of storage media. One or more of the devices 320, 330, 350, and 360 may also have their own memory components.

The processing device 320, according to the first exemplary embodiment, is preferably a hardware device for executing software located in the memory 340 as is described in more detail below. For example, the processing device 320 may be any custom made or commercially available processor, such as, the processor 220 shown in FIG. 2, a central processing unit (CPU), a semiconductor based microprocessor (in the form of a microchip or chip set), macroprocessor, or any other device for executing software instructions. The processing device 320 may be a central processing unit (“CPU”) or an auxiliary processor among several processors associated with the communication device 310. Examples of suitable commercially-available processing devices comprise, but are not limited to, the PA-RISC series of microprocessors from Hewlett-Packard Company, U.S.A., the 80x86 and Pentium series of microprocessors from Intel Corporation, U.S.A., PowerPC microprocessors from IBM, U.S.A., Sparc microprocessors from Sun Microsystems, Inc, and the 68xxx series of microprocessors from Motorola Corporation, U.S.A.

The embedded imaging device 330 captures images from one or more sources and provides the images in an electronic format. For example, the embedded imaging device 330 may comprise a scanner 230 (FIG. 2) for capturing images from paper documents (and/or other substrate sources) and providing the captured images in a bitmap format. However, other types of imaging devices may also be provided within the communication device 310, such as, but not limited to, copiers and/or cameras for capturing a variety of visible and/or non-visible images (such as infrared images) from a variety of sources. The imaging device 330 may also be arranged to capture and provide non-image data from sensors, such as mechanical, electrical, chemical, and/or other sensory data.

The memory 340 has various software stored therein for execution by the processing device 320. For example, as illustrated in FIG. 3, the memory 340 comprises an operating system 341. Depending on the particular configuration in which the communication device 310 is implemented, the operating system 341 may be any of the following, or other, operating systems: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, and Sun Microsystems, Inc.; (e) a LINUX operating system, which is freeware that is readily available on the Internet; (f) a run time Vxworks operating system from WindRiver Systems, Inc.; or (g) an appliance-based operating system, such as PalmOS available from Palm Computing, Inc. and Windows CE available from Microsoft Corporation). The operating system 341 essentially controls the execution of other computer programs stored in the memory 340 and provides scheduling, input-output control, file and data management, memory management, and communication control and related services.

The memory 340 also comprises at least an image converter module 342 for converting image data from the imaging device 330 into other image data formats. For example, when the imaging module 330 is in the form of a scanner (such as the scanner 230 shown in FIG. 2), the image converter module 342 may convert bitmap data from the scanner into portable document format (.pdf) or tagged image file format (.tiff). Support for other data file types may also be provided by the image converter device 342 comprising, but not limited to, CAM Casio digital camera format, (EMF) Enhanced Metafile Format, (EPS) Encapsulated PostScript (TIFF preview) format, FlashPix format (FPX), Graphics Interchange Format (GIF), IMG GEM Raster image formats, JPG and Joint Photographic Experts Group (JPEG) formats, Kodak digital camera (KDC) format, QuickTime Movie format (MOV), Portable Bitmap File (PBM) format, PCX PC Paintbrush format, Portable Greymap File (PGM) format, Portable Network Graphics (PNG) format, Portable Pixelmap (PPM) format, PSD Adobe Photoshop format, Paint Shop Pro (PSP) file format, QuickTime image (QTIF) format, Structured FAX file (SFF) format, Seattle Film Works (SFW) format, (SWF) Macromedia's Flash/Shockwave format, (TGA) Truevision Advanced Raster Graphics Adapter (TARGA) format, .tiff, WAP Bitmap (WBMP) format, Windows Metafile (WMF) format, X11 Bitmap (XBM) format, XPM X11 Pixmap format, and/or other formats.

In accordance with the first exemplary embodiment of the invention, the memory 340 also comprises a recipient preference system 343. The recipient preference system 343 associates each recipient with a preferred electronic format for receiving a scanned image. For example, the preferred electronic format may include a predetermined file type, comprising, but not limited to, the file types listed above. Alternatively, or in addition, another embodiment of an electronic format for a recipient according to the first exemplary embodiment may comprise an image resolution, or file size limitation. These and other electronic format designations are useful for providing each recipient with an image of the paper document which is suitable for use by the particular recipient. For example, each recipient may use different hardware and/or software systems for receiving document images.

The recipient preference system 343 may be a source program (or “source code”), executable program (“object code”), script, or any other entity comprising a set of instructions to be performed. In order to work with a particular operating system 341, any such source code will typically be translated into object code via a conventional compiler, assembler, interpreter, or the like, which may (or may not) be comprised within the memory 340. The recipient preference system 343 may be written using an object oriented programming language having classes of data and methods, and/or a procedure programming language, having routines, subroutines, and/or functions. For example, suitable programming languages comprise, but are not limited to, C, C++, Pascal, Basic, Fortran, Cobol, Perl, Java, and Ada.

When the recipient preference system 343 is implemented in software, as shown by FIG. 3, the system 343 can be stored on any computer readable medium for use by, or in connection with, any computer-related system or method. In the context of this document, a “computer readable medium” comprises any electronic, magnetic, optical, or other physical device or means that can contain or store a computer program for use by, or in connection with, a computer-related system or method. The computer-related system may be any instruction execution system, apparatus, or device, such as a computer-based system, processor-containing system, or other system that can fetch the instructions from the instruction execution system, apparatus, or device and then execute those instructions. Therefore, in the context of this document, a computer-readable medium can be any means that will store, communicate, propagate, or transport the program for use by, or in connection with, the instruction execution system, apparatus, or device.

For example, the computer readable medium may take a variety of forms comprising, but is not limited to, an electronic, magnetic, optical, electromagnetic, infrared, or semiconductor system, apparatus, device, or propagation medium. More specific examples of a computer-readable medium comprise, but are not limited to, an electrical connection (electronic) having one or more wires, a portable computer diskette (magnetic), a random access memory (“RAM”) (electronic), a read-only memory (“ROM”) (electronic), an erasable programmable read-only memory (“EPROM,” “EEPROM,” or Flash memory)(electronic), an optical fiber (optical), and a portable compact disc read-only memory (“CDROM”) (optical). The computer readable medium could even be paper or another suitable medium upon which the program is printed, as the program can be electronically captured, for instance via optical sensing or scanning of the paper, and then compiled, interpreted or otherwise processed in a suitable manner before being stored in the memory 340.

In another embodiment, where the recipient preference system 343 is at least partially implemented in hardware, the recipient preference system 343 may be implemented using a variety of technologies comprising, but not limited to, discrete logic circuit(s) having logic gates for implementing logic functions upon data signals, application specific integrated circuit(s) (“ASIC”) having appropriate combinational logic gates, programmable gate array(s) (“PGA”), and/or field programmable gate array(s) (“FPGA”).

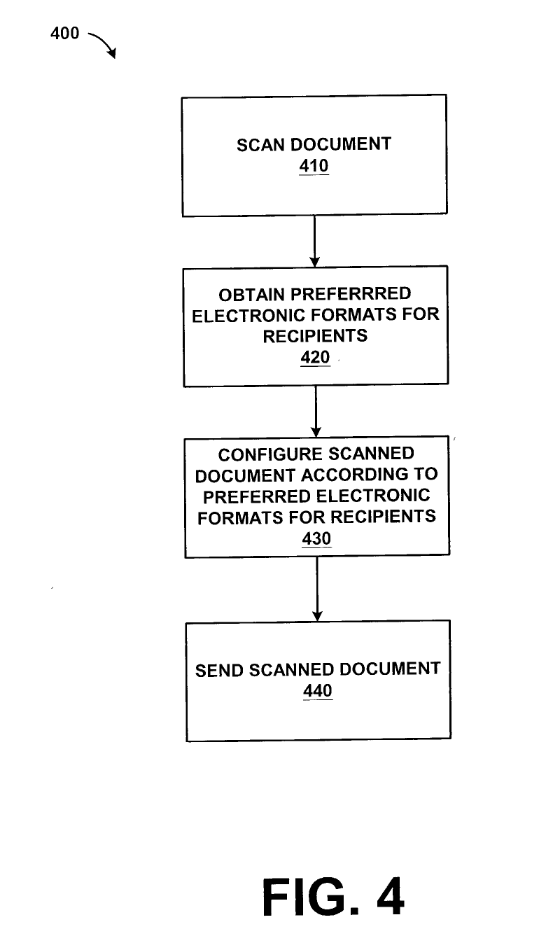

FIG. 4 is a flow chart 400 illustrating a communication method for distributing an image of a paper document to a plurality of recipients, in accordance with the first exemplary embodiment of the invention. Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

Referring to FIG. 4, as shown by block 410, a paper document is scanned or otherwise imaged. For example, the paper document may be imaged by the imaging device 330 shown in FIG. 3. The preferred electronic format information is then obtained (block 420). For example, the recipient preference system 343 (FIG. 3) may comprise a database 344 (FIG. 3), or other data structure that associates each recipient with a preferred electronic format for receiving the scanned image. Alternatively, the recipient preference system 343 (FIG. 3) may be provided as a client that requests the recipient preference data from a server, such as the e-mail server 120 of FIG. 1.

As shown by block 430, the scanned document is then configured according to the preferred electronic format for each recipient. For example, the image converter 342 (FIG. 3) may convert a bitmap provided by the imaging device 330 (FIG. 3) into another file type, resolution, or file size, such as by file compression. Once the bitmap has been converted to the preferred electronic format for one or morc recipients, the bitmap is sent to the recipients (block 440). Documents may be sent after each conversion, or the converted documents may be saved in the memory 340 (FIG. 3) and sent together at a future designated time.

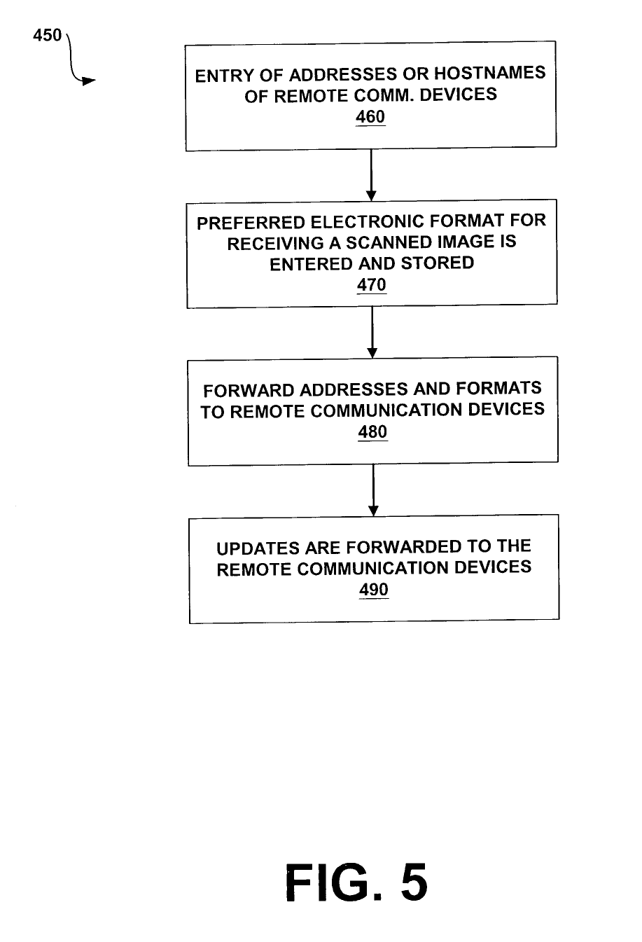

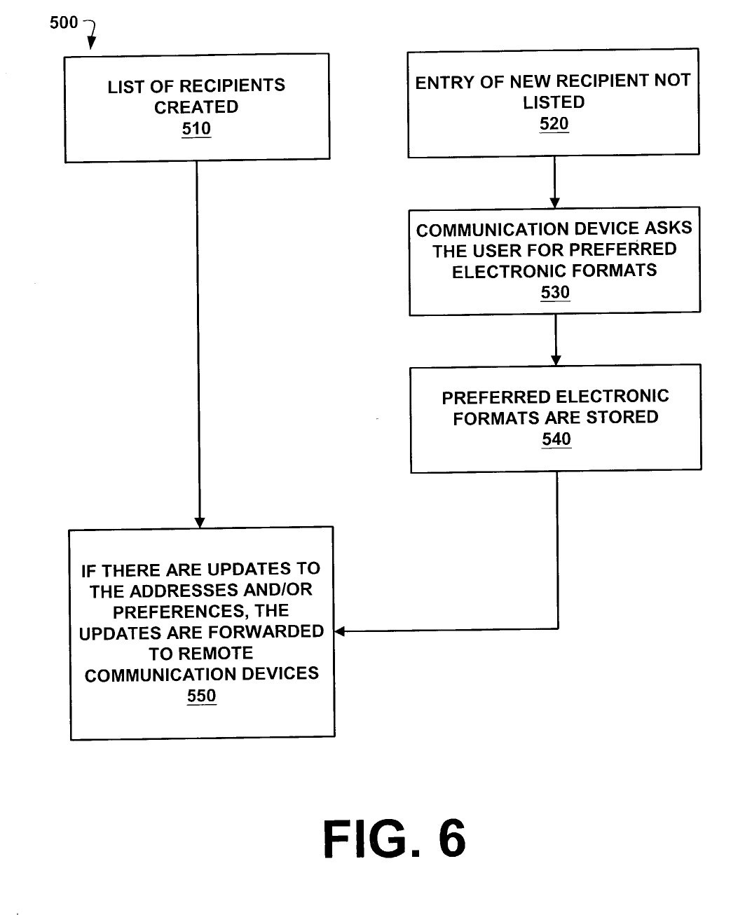

FIG. 5 is a flowchart 450 illustrating preparation of the communication device 310 (FIG. 3) for distributing an image of a document to a recipient in a preferred format. As shown by block 460, an administrator enters addresses or hostnames of remote communication devices, such as additional communication devices, also referred to as remote communication devices, that are located within the same network as the present communication device 310 (FIG. 3). It should be noted that the entered addresses may be IP addresses or a different category of address. The addresses are stored within the database 344 (FIG. 3) for future use by the communication device 310 (FIG. 3). A preferred electronic format for receiving a scanned image is entered and stored, in addition to the address of the remote communication device for each remote communication device (block 470).

As shown by block 480, the addresses and preferred electronic formats are forwarded to the remote communication devices for addition to their databases. If there are updates of addresses and/or preferences provided to the database 344 (FIG. 3), the updates are also forwarded to the remote communication devices (block 490). To prevent a communication device (remote or present) from receiving an update having information previously received, each update contains a list of addresses of communication devices that have previously received the update. When a communication device receives the database update, it queries the list of addresses and does not forward the database update to communication devices on the list. Therefore, each communication device receives the update once.

FIG. 6 is a flowchart 500 illustrating use of the communication device 310 (FIG. 3) while scanning and/or sending a document. As shown by block 510, a user of the communication device 310 (FIG. 3) creates a list of recipients to receive a scanned document by selecting from a list of known recipient names that may also be stored within the database 344 (FIG. 3). Preferably, each recipient name is stored with the address of a communication device.

Alternatively, the user may enter a new recipient that is not listed within the list of known recipient names (block 520). In accordance with a second exemplary embodiment of the invention, the user may enter an electronic mail (e-mail) address associated with each recipient. If the user enters a new recipient, the communication device 310 (FIG. 3) asks the user for electronic formats preferred by the new recipient (block 530). User responses identifying preferred electronic formats are then stored within the database 344 (FIG. 3) (block 540). If there are updates of addresses and/or preferences provided to the database 344 (FIG. 3), the updates are also forwarded to the remote communication devices (block 550). To prevent a communication device from receiving an update having information previously received, each update contains a list of addresses of communication devices that have previously received the update. When a communication device receives the database update, it queries the list of addresses and does not forward the database update to communication devices on the list. Therefore, each communication device receives the update once.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A communications device for distributing an image of a paper document to a plurality of recipients, comprising:
a database comprising a preferred electronic format of each of the recipients; and
an imaging device for converting the paper document into the preferred electronic format for each recipient in the database prior to distribution of the document in the preferred electronic format.

2 The device recited in claim 1, wherein said preferred electronic format of each recipient comprises a predetermined file type.

3. The device recited in claim 1, wherein the preferred electronic format comprises a predetermined image resolution.

4. The device recited in claim 1, wherein the preferred electronic format comprises a file size limitation.

5. The device recited in claim 1, further comprising a local memory for storing the database.

6. The device recited in claim 5, wherein said preferred electronic format comprises attributes selected from the group consisting of a predetermined file type, image resolution, and file size limitation.

7. In a communications device of the type having a document scanner for distributing an image of a paper document to a plurality of recipients, the improvement comprising:
means for associating each recipient with a preferred electronic format; and
means for converting the image into the preferred electronic format for each recipient prior to distribution.

8. The device recited in claim 7 wherein the associating means further comprises a client for requesting the preferred electronic format for each recipient from a server.

9. The device recited in claim 8 wherein the associating means further comprises a server for responding to requests from the client.

10. The device recited in claim 9 wherein the server comprises a database of preferred electronic formats for each recipient.

11. The device recited in claim 10 wherein the preferred electronic format for each recipient comprises a predetermined file type.

12. The device recited in claim 11 wherein the preferred electronic format for each recipient further comprises a file size limitation.

13. The device recited in claim 12 wherein the preferred electronic format for each recipient further comprises an image resolution.

14. A communications method for distributing an image of a paper document to a plurality of recipients, the method comprising the steps of:
associating each recipient with a preferred electronic format for receiving the image; and
scanning the image according to the preferred electronic format for each recipient prior to distribution of the image.

15. The method recited in claim 14 wherein the scanning step further comprises the step of converting a scanned bitmap into the preferred electronic format.

16. The method recited in claim 15, the preferred electronic format comprises a predetermined file type.

17. The method recited in claim 16 wherein the preferred electronic format comprises a predetermined file size limitation.

18. The method recited in claim 14 wherein the preferred electronic format comprises a predetermined image resolution.

19. The method recited in claim 14 wherein the associating step further comprises the step of sending a request to a server.

20. The method recited in claim 19 wherein the associating step further comprises the step of querying a database arranged on the server.
